(19) United States
(12) Patent Application Publication
(10) Pub. No.: US 2022/0205781 A1
(43) Pub. Date: Jun. 30, 2022

(54) SYSTEM AND METHOD FOR MONITORING TILT OF A STRUCTURE

(71) Applicant: DMI, LLC, Dubuque, IA (US)

(72) Inventors: Nathan Lee Greiner, Hanover, IL (US); Brian Alan Vesperman, Madison, WI (US); Christopher John Kuehl, North Barrington, IL (US)

(21) Appl. No.: 17/139,377

(22) Filed: Dec. 31, 2020

(51) Int. Cl. G01B 21/22; G01S 19/01; G01K 13/024; G01P 15/00; G01P 5/02; G01P 13/00

(52) U.S. Cl. CPC G01B 21/22; G01S 19/01; G01P 13/0006; G01P 15/00; G01P 5/02; G01K 13/024

(57) ABSTRACT

A sensor system includes a tilt sensor including an accelerometer configured to measure an angle of tilt of a vertical structure, and a wind sensor configured to determine at least one of wind speed or wind direction. The tilt sensor can also include a communication interface configured to transmit a sensor signal including the angle of tilt of the vertical structure, and at least one of the wind speed or the wind direction. The sensor system can also include a controller for receiving the sensor signal, and a cloud computing network that allows for various alerts to be presented to a user device.

### TECHNICAL FIELD

The present invention relates to a system that includes one or more sensors for monitoring the tilt of a vertical structure.

### BACKGROUND

Vertical structures such as utility poles or towers can be affected by environmental factors such as high winds or by external factors making contact with the structure. When the vertical structure is caused to tilt or bend, the integrity of the structure may be comprised. Regular surveillance and visual inspections can reduce the likelihood of negative consequences caused by the structure's tilt.

### SUMMARY

This summary is provided herein to help enable a general understanding of various aspects of exemplary, non-limiting embodiments that follow in the more detailed descriptions and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a sensor system includes a tilt sensor. The tilt sensor includes an accelerometer configured to measure at least one of an angle of tilt, or a change in angle of tilt of a vertical structure, a wind sensor configured to determine at least one of wind speed or wind direction, and a communication interface configured to transmit a sensor signal including at least one of the angle of tilt of the vertical structure or the change in angle of tilt, and at least one of the wind speed or the wind direction.

In certain embodiments, the tilt sensor further comprises a GPS receiver, and the sensor signal further includes a geographic location of the tilt sensor obtained by the GPS receiver.

In certain embodiments, the accelerometer is configured to measure at least one of the angle of tilt or change in angle of tilt periodically at an interval of time.

In certain embodiments, the interval of time is determined by a user.

In certain embodiments, the tilt sensor is configured to determine whether the angle of tilt exceeds a tilt threshold, or the change in angle of tilt exceeds a tilt change threshold.

In certain embodiments, the communication interface is configured to remain inactive while the angle of tilt does not exceed the tilt threshold, and the tilt sensor is configured to activate the communication interface based on determining that the angle of tilt exceeds a tilt threshold.

In certain embodiments, the communication interface is configured to transmit the sensor signal upon activation.

In certain embodiments, the tilt sensor further includes a thermometer configured to measure air temperature, and the sensor signal further includes the air temperature.

In certain embodiments, the sensor system further includes a controller configured to receive the sensor signal.

In certain embodiments, the sensor system further includes a server. The server is configured to receive, from the controller, the angle of tilt, determine that the angle of tilt exceeds a predefined tilt threshold, and based on determining that the angle of tilt exceeds the predefined tilt threshold, provide a tilt alert to a user device.

In certain embodiments, the server is further configured to receive, from the controller, the wind speed, determine that the wind speed exceeds a predefined wind speed threshold, and based on determining that the wind speed exceeds the predefined wind speed threshold, provide a wind speed alert to a user device.

In certain embodiments, the server is further configured to provide the wind speed alert based on the wind speed and the wind direction.

In various, non-limiting embodiments, a method of monitoring tilt of a vertical structure includes detecting at least one of an angle of tilt or a change in angle of tilt of the vertical structure, detecting at least one of a wind speed or a wind direction at the vertical structure, and transmitting a sensor signal that includes at least one of the angle of tilt or the change in angle of tilt, and at least one of the wind speed or wind direction.

In certain embodiments, detecting the angle of tilt or the change in angle of tilt is performed periodically at an interval of time.

In certain embodiments, the interval of time is determined by a user.

In certain embodiments, the method further includes determining whether the angle of tilt exceeds a tilt threshold, or the change in angle of tilt exceeds a tilt change threshold.

In certain embodiments, transmitting the sensor signal is performed based on the determination that the angle of tilt exceeds the tilt threshold.

In various, non-limiting embodiments, a method of monitoring tilt of a vertical structure includes receiving a sensor signal from a tilt sensor, the sensor signal including an angle of tilt of the vertical structure, determining that the angle of tilt exceeds a predefined tilt threshold, and providing a tilt alert to a user device based on the determination that the angle of tilt exceeds the predefined tilt threshold.

In certain embodiments, the sensor signal further includes a wind speed as measured by the tilt sensor, and the method further includes determining that the wind speed exceeds a predefined wind speed threshold, and providing a wind speed alert to the user device based on the determination that the wind speed exceeds the predefined wind speed threshold.

In certain embodiments, the sensor signal further includes a wind direction as measured by the tilt sensor, and the method further includes providing the wind speed alert based on the wind speed and the wind direction.

These and other features of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a schematic representation of an exemplary tilt sensor system;

FIG. 2A is a schematic representation of an exemplary tilt sensor;

FIG. 2B is a front view of an exemplary tilt sensor;

FIG. 2C is a rear view of an exemplary tilt sensor;

FIG. 3 is a side view of a vertical structure equipped with an exemplary tilt sensor;

FIG. 4 is a side view of a vertical structure equipped with an exemplary tilt sensor;

FIG. 5 is a flow diagram depicting a method of monitoring tilt of a structure; and

FIG. 6 is a flow diagram depicting a method for sensing parameters pertaining to a vertical structure.

### DETAILED DESCRIPTION

Vertical structures such as utility poles, high-tension line support towers, and mobile communication towers can be valuable assets as part of infrastructure. Damage or destruction of a vertical structure can cause great damage to, and/or interrupt, utility and communication systems that rely on the integrity of the vertical structure. It is beneficial to have a system for monitoring vertical structures in order to prevent damage to the vertical structure and to quickly respond to any damage that does occur. In accordance with various embodiments described herein, a tilt monitoring system includes one or more tilt sensors for monitoring tilt of a vertical structure. The tilt sensors can sense the tilt of a vertical structure as well as various environmental parameters relative to the vertical structure and its immediate environment. The tilt sensors can communicate with a controller to process sensor data. The controller can determine various information using the sensor data. Such information can be transmitted to a server for storage in a database. Further, based on the information, the controller and/or server can generate notifications or alerts related to the vertical structure. A user may use a user device such as a computer, a mobile device, or other computing device to view the information, notifications, and alerts. Additional advantages of the embodiments provided herein will be apparent to one of ordinary skill in the art.

With reference to the drawings, like reference numerals designate identical or corresponding parts throughout the several views. The inclusion of like elements in different views does not mean a given embodiment necessarily includes such elements or that all embodiments of the invention include such elements. The examples and figures are illustrative only and not meant to limit the invention, which is measured by the scope and spirit of the claims. Moreover, it should be understood that the drawings may not depict features to scale. The drawings may enlarge or exaggerate certain features to facilitate visualization.

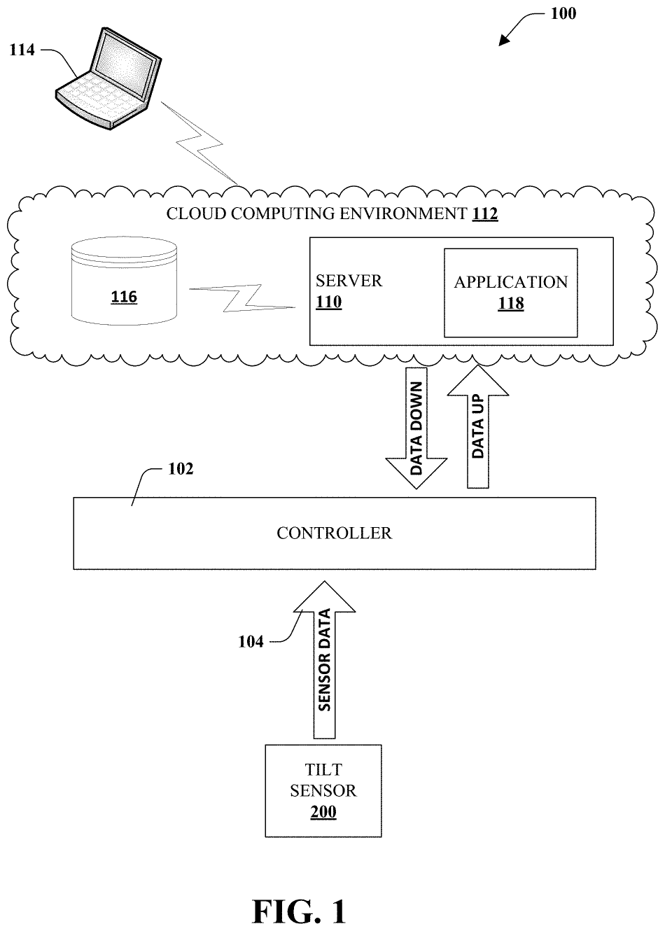

FIG. 1 depicts an exemplary tilt monitoring system 100. The tilt monitoring system 100 can include a controller 102 configured to communicate with a tilt sensor 200. The controller 102, which can also be referred to as a gateway, can receive data from various sensors via a wired or wireless communication link. For example, the controller 102 can receive a sensor signal 104 from the tilt sensor 200. The sensor signal 104 can include information as described below in greater detail. The controller 102 can be located locally to the various sensors, or remotely. The controller 102 can receive the sensor signal 104, store the corresponding information, and/or perform various processing or calculations with the information.

In certain embodiments, the controller 102 can also communicate the sensor information in a raw or a processed form to a server 110. It should be appreciated that the server 110 can be local, remote, or cloud-based as part of a cloud computing environment 112. In various embodiments, the controller 102 can exist as part of the server 110. The server 110 can also be distributed among multiple locations and/or devices. It is to be appreciated that the server 110 can be at least one of a website, a server device, a computer, a cloud-service, a processor and memory, or a computing device connected to the Internet and connected to a user device 114. In general, a network can be implemented to couple one or more devices of system 100 via wired or wireless connectivity, over which data communications are enabled between devices and between the network and at least one of a second network, a subnetwork of the network, or a combination thereof. It is to be appreciated that any suitable number of networks can be used with the subject innovation and data communication on networks can be selected by one of sound engineering judgment and/or one skilled in the art.

In certain embodiments, the cloud computing environment 112 can also include a database 116. The database 116 can receive information from the server 110 regarding sensor information, alerts, notifications, historic sensor information, user information, among other information. The database 116 may be a standalone storage component or it may exist as part of the server 110.

A user device 114 may communicate with the cloud computing environment 112 to send and receive information to and from the server 110 and/or the database 116. The user device 114 may be, for example, a computer, or a mobile device such as a smartphone or tablet, a wearable device, among others. The user device 114 may interact with an application 118 operating on the server 110. When executed, the application 118 can interact with the user device 114 to allow a user to view sensor information, view corresponding notifications or alerts, manipulate sensor information, or update settings for the server 110, application 118, controller 102, or tilt sensor 200. The user device 114 can provide a user interface that allows for user interactions with the application 118. It should be appreciated that in certain embodiments, the application 118 may also exist locally on the user device 114 and receive information from the server 110.

One of ordinary skill in the art can appreciate that the various embodiments of the application 116 described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices or user device 114 can access the computing services or functionality via application program interfaces (APIs), web browsers, or other standalone or networked applications. Accordingly, aspects of the application 118 can be implemented based on such a cloud environment. For example, the application 118 can reside in the cloud computing environment 112 such that the computer-executable instructions implementing the functionality thereof are executed with the aggregated computing resources provided by the plurality of physical computing devices. The cloud computing environment 112 provides one or more methods of access to the subject innovation, which are utilized by the application 118. In an embodiment, software and/or a component can be installed on the user device 114 to allow data communication between the user device 114 and the cloud computing environment 112. These methods of access include IP addresses, domain names, URLs, etc. Since the aggregated computing resources can be provided by physical computing device remotely located from one another, the cloud computing environment 112 can include additional devices such as a routers, load balancers, switches, etc., that appropriately coordinate network data.

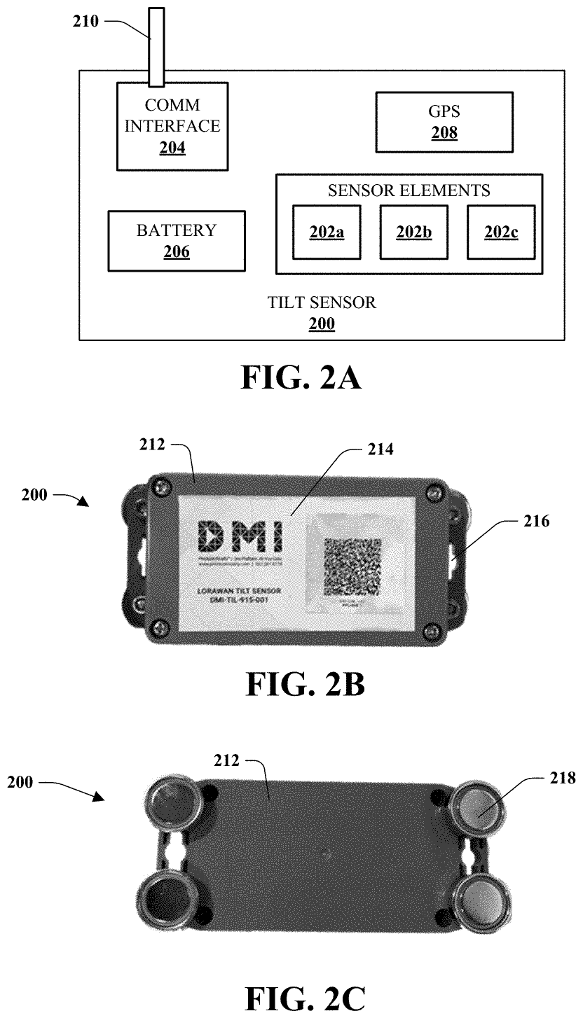

Turning now to FIG. 2A, the sensor system 100 can include a tilt sensor 200. The tilt sensor 200 can include a plurality of sensing elements. The sensing elements can include a sensor for detecting tilt (e.g. an accelerometer 202a), a thermometer 202b for measuring temperature, and a wind sensor 202c configured to detect wind speed and/or direction (e.g. an anemometer). The tilt sensor 200 can further include a communication interface 204 for transmitting a sensor signal 104. The tilt sensor 200 can be powered by a power source such as battery 206. The tilt sensor 200 can further include a GPS receiver 208. An antenna 210 can be included to assist in transmission and reception of wireless signals and/or receive GPS signals.

The tilt sensor 200 can further include an enclosure 212 that houses the internal components of the tilt sensor 200, as shown in FIGS. 2B and 2C. A label 214 may be affixed to the enclosure 212, and may include information such as operational information of the tilt sensor 200, identifying information such as a serial number or part number, information regarding the owner of the tilt sensor 200, and/or an indicia (e.g. a barcode, web link, QR code, etc.) that, when scanned by a mobile device, can cause a mobile device to display information pertaining to the tilt sensor 200 or the vertical structure that the tilt sensor 200 is configured to monitor. In one example, the indicia, when scanned by a mobile device such as the user device 114, can cause the mobile device to navigate to information contained on the cloud computing environment 112.

The tilt sensor 200 can include mounting hardware attached to the enclosure 212. For example, one or more loops 216 can be attached to the enclosure 212 to allow for a mounting strap or clamp to be fed through the loops 216 and around a portion of the vertical structure. In other embodiments, a fastener such as a screw, bolt, or a nail may be inserted through the loop 216 and used to mount the tilt sensor 200 directly to the vertical structure. In certain other embodiments, one or more magnets 218 can be attached to the enclosure 212. The magnets 218 can secure the tilt sensor 200 to a magnetic vertical structure.

It should be appreciated that the tilt monitoring system 100 can include a single tilt sensor 200, or it can include a plurality of tilt sensors 200. Each tilt sensor 200 can have a unique tilt sensor identifier (e.g. a unique number or name associated with the tilt sensor 200). The tilt sensor identifier can be transmitted from the tilt sensor 200 and included in the sensor signal 104.

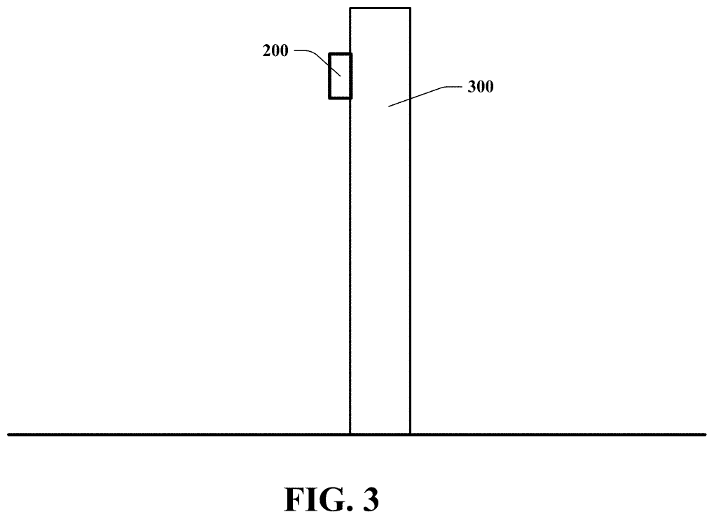

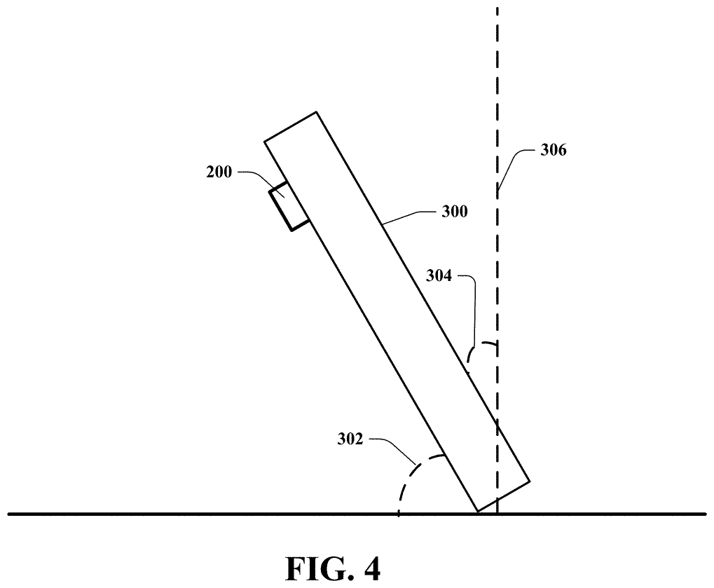

In an embodiment depicted in FIG. 3, the tilt sensor 200 can be installed on a vertical structure 300 such as a pole. For example, the tilt sensor 200 can be installed on a utility pole, a wire support tower, a cell phone tower, an antenna, a building, or any other vertical structure. The tilt sensor 200 can be mounted using mounting hardware that can include one or more fasteners such as screws, clamps, nails, clamp rings, suction cups, magnets 218, straps, and adhesives, among others. As shown in FIG. 4, the accelerometer 202a included in the tilt sensor 200 can measure the angle of tilt 302 of the vertical structure 300 with respect to the ground. In another embodiment, the angle of tilt 304 is measured with respect to a vertical axis 306 at a ninety-degree angle with the ground. In certain embodiments, the accelerometer 202a can detect the direction of tilt of the vertical structure 300. For example, the accelerometer 202a can determine a cardinal direction (e.g. North, South, East, or West) or a direction angle (e.g. 0 to 360 degrees) at which the vertical structure 300 is tilted at its degree of tilt 302, 304.

In addition to detecting tilt of the vertical structure 300, the tilt sensor 200 can also sense parameters corresponding to the local environment of the vertical structure 300, including wind speed, wind direction, and temperature. As a result, the tilt sensor 200 is able to provide micro-climate monitoring for the immediate surroundings of the vertical structure 300. The thermometer 202b can measure the air temperature at the vertical structure 300 and the wind sensor 202c can measure the wind speed and/or the wind direction at the vertical structure 300.

The tilt sensor 200 can transmit a sensor signal 104 to the controller 102. The sensor signal 104 can contain information regarding one or more of the angle of tilt 302, 304 of the vertical structure 300, a percentage change in tilt of the vertical structure 300 (within an accuracy of 0.1%), a change in angle of tilt of the vertical structure 300, the air temperature, the wind speed and direction, tilt sensor identifier, or the geographic location of the tilt sensor 200 as measured by the GPS receiver 208. In certain embodiments, the tilt sensor 200 can transmit the sensor signal 104 to the controller at predetermined intervals. For example, the tilt sensor 200 can take measurements periodically and transmit the sensor signal 104 at regular intervals of time. A user may define the interval at which measurements are taken and/or at which the sensor signal 104 is transmitted.

In other embodiments, the accelerometer 202a can monitor the angle of tilt 302, 304, percentage change in tilt, or degree change in tilt, and compare the value to a corresponding threshold angle, percentage change, or degree change. When the value exceeds the corresponding threshold angle, percentage change, or degree change, the communication interface 204 can be activated and transmit the sensor signal 104. The transmission of the sensor signal 104 based on the value exceeding the corresponding threshold angle, percentage change, or degree change can also trigger an alert for a user as described further below. In still further embodiments, the communication interface 204 can be activated and transmit the sensor signal 104 based upon a comparison of the air temperature, wind speed, or wind direction to a threshold or specific condition. Similarly, the transmission of the sensor signal 104 based on the air temperature, wind speed, or wind direction exceeding a threshold or satisfying a specific condition can trigger an alert for a user as described further below. Transmitting the sensor signal 104 only upon a parameter exceeding a corresponding threshold value conserves energy by only activating the communication interface 204 when necessary to alert a user.

In certain embodiments, the controller 102 can create processed vertical structure information using the information received as part of the sensor signal 104. For example, the controller 102 can record timestamps for various receptions of the sensor signal 104, and can also calculate a percentage change of angle of tilt or degree change in angle of tilt from comparing the present angle of tilt 302, 304 to a previous angle of tilt 302, 304. The controller 102 can communicate the processed vertical structure information (e.g. timestamped information from the sensor signal 104, or calculated percent or degree change of tilt) or the raw information from the sensor signal 104 to the server 110. The server 110 may store this information in the server 110 and/or in the database 116, from which a user may access the information via the user device 114. The user device 114 may provide a display that allows the user to view any of the parameters included in the sensor signal 104, including angle of tilt 302, 304, air temperature, wind speed, or wind direction. The user device 114 may display these parameters in real time, and the user device 114 may also display a historical record of the parameter values. In one embodiment, the historical record of the parameter values can be displayed on the user device 114 in the form of a line graph. In one example, angle of tilt 302, 304, percentage change of angle of tilt, or degree change of angle of tilt can be plotted over time. The historical record can be stored locally on the user device 114 or it may be stored on the cloud computing environment 112 (e.g. in database 116 or server 110).

In certain embodiments, when any of the measured parameters, including angle of tilt 302, 304, percentage change in tilt of the vertical structure 300, change in angle of tilt of the vertical structure 300, air temperature, wind speed, or wind direction exceed a corresponding predetermined threshold, a rule configured within the application 118 then causes an alert to notify a user via the user device 114 that a threshold has been exceeded. The alert can inform the user that emergency maintenance or preventative maintenance is required on the vertical structure 300. An alert may be presented to a user directly via a user device 114, or by way of SMS text message or e-mail accessible via a user device 114. An alert can be geo-tagged by including information regarding the geographic location of the tilt sensor 200 corresponding with the alert as provided by the GPS receiver 208. The alerts can be configured by a user. For example, a user may set the corresponding thresholds for each parameter used to trigger an alert. In another example, a user may customize the information displayed or included within an alert. Such information can include any of the angle of tilt 302, 304, change in angle of tilt, the air temperature, the wind speed, the wind direction, a tilt sensor identifier, or the geographic location of the tilt sensor 200. In one embodiment, when the angle of tilt 302, 304 exceeds a predetermined tilt threshold, an alert may be generated to notify a user via the user device 114 that the vertical structure has an angle of tilt 302, 304 that is exceeding the threshold. Further, the user device 114 could display the actual value of the angle of tilt 302, 304 so that the user can determine whether the vertical structure 300 has fallen over or whether the vertical structure 300 is tilted to an extent that puts the vertical structure 300 in danger of falling over.

In certain embodiments, the tilt monitoring system 100 can perform micro-climate monitoring by analyzing one or more of the air temperature, wind speed, or wind direction with respect to the angle of tilt 302, 304. It should be appreciated that the micro-climate monitoring analysis can be performed by one or more of the controller 102, the server 110, or the user device 114. Using micro-climate monitoring of the immediate environment of the vertical structure 300, the tilt monitoring system can predict weather situations that could cause damage or excessive tilt to the vertical structure 300. Various additional alerts can be presented to a user via the user device 114. For example, when the wind speed exceeds a predetermined threshold, a wind alert may be generated to notify a user via the user device 114 that the vertical structure 300 is experiencing wind speeds in excess of the wind speed threshold. Further, the user device 114 could display the actual wind speed. In certain embodiments, when the tilt monitoring system 100 analysis wind speed, it may also take into consideration the wind direction. For example, the tilt monitoring system 100 can determine a vector map of the force of the wind on the vertical structure 300 to determine the force that the wind is exerting on the vertical structure 300 in different directions. Using the information about wind direction, the tilt monitoring system 100 can apply a lower wind speed threshold if the wind direction is causing a force in the direction that the vertical structure 300 is tilting, or the tilt monitoring system 100 can apply a higher wind speed threshold if the wind direction is causing a force in the direction opposite of the vertical structure's 300 tilt.

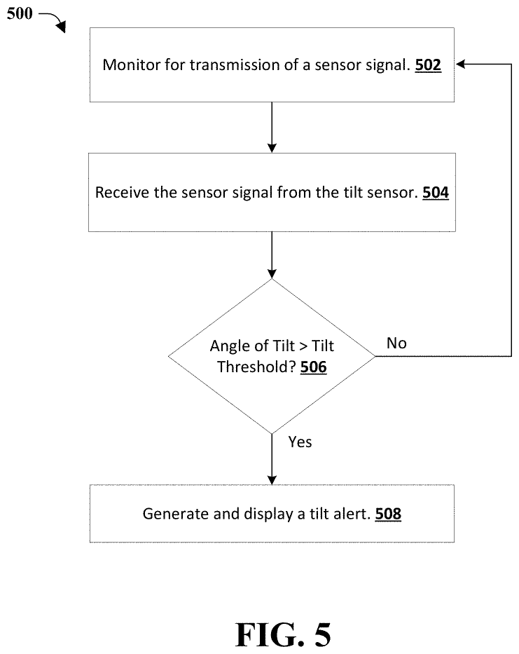

Turning now to FIG. 5, a method 500 for monitoring tilt of a vertical structure 300 is depicted. Method 500 may be performed by, for example, the controller 102, the server 110, the user device 114, or any combination of the controller 102, the server 110, and the user device 114. At numeral 502, a tilt sensor 200 is monitored for transmission of a sensor signal 104. At numeral 504, the sensor signal 104 is received from the tilt sensor 200. At numeral 506, an angle of tilt 302, 204 communicated from the sensor signal 104 is compared to a predefined tilt threshold. If the angle of tilt 302, 304 does not exceed the predetermined threshold, the method returns to numeral 502 and continues to monitor for transmission of the sensor signal 104. If the angle of tilt 302, 304 exceeds the predetermined threshold, the method continues to numeral 508, where a tilt alert is generated and displayed to a user to indicate that the angle of tilt 302, 304 of the vertical structure has exceeding the tilt threshold.

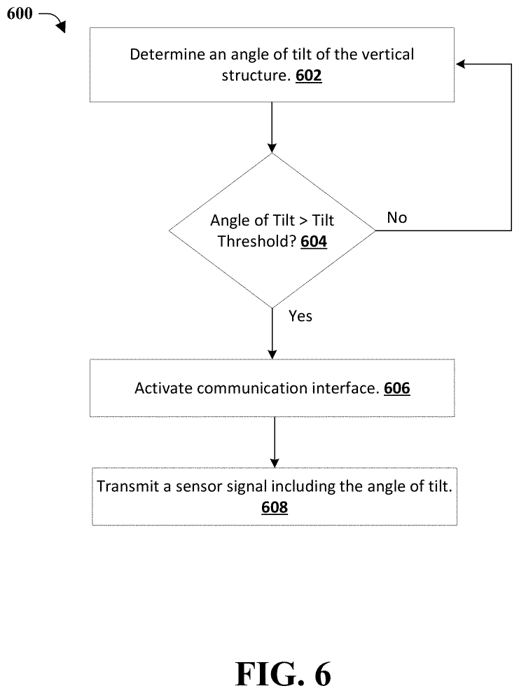

As described above, the tilt sensor 200 can detect parameters including angle of tilt 302, 304, air temperature, wind speed, and/or wind direction continuously or at predetermined intervals. The tilt sensor 200 can transmit the sensor signal 104 containing the measured parameters continuously or at the predetermined intervals. Alternatively, the tilt sensor 200 can transmit the sensor signal 104 at times determined by comparing the parameters to corresponding parameter thresholds. For example, FIG. 6 depicts a method 600 for sensing parameters pertaining to a vertical structure 300. The method 600 can be performed, for example, by the tilt sensor 200. It should be appreciated that the methods 600 and 500 may be performed as part of the same method, separately, or simultaneously. At numeral 602, the tilt sensor 200 determines angle of tilt 302, 304 of the vertical structure 300. At numeral 604, the tilt sensor 200 compares the angle of tilt 302, 304 to a tilt threshold. If the angle of tilt 302, 304 is less than the tilt threshold, the method 600 returns to numeral 602, where the tilt sensor 200 continues to determine the angle of tilt 302, 304. If the angle of tilt 302, 304 exceeds the tilt threshold, the method 600 proceeds to numeral 606, where the communication interface 204 is activated. At numeral 608, the communication interface 204 transmits a sensor signal 104 including the angle of tilt 302, 304. For example, the communication interface 204 can transmit the sensor signal 104 to the controller 102.

It is to be appreciated that various features or aspects of the embodiments described herein can be utilized in any combination with any of the other embodiments.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean “serving as an illustration or example of something.”

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sensor system, comprising
a tilt sensor comprising:
an accelerometer configured to measure at least one of an angle of tilt, or a change in angle of tilt of a vertical structure;
a wind sensor configured to determine at least one of wind speed or wind direction; and
a communication interface configured to transmit a sensor signal including at least one of the angle of tilt of the vertical structure or the change in angle of tilt, and at least one of the wind speed or the wind direction.

2. The sensor system of claim 1, wherein the tilt sensor further comprises a GPS receiver, and the sensor signal further includes a geographic location of the tilt sensor obtained by the GPS receiver.

3. The sensor system of claim 1, wherein the accelerometer is configured to measure at least one of the angle of tilt or change in angle of tilt periodically at an interval of time.

4. The sensor system of claim 3, wherein the interval of time is determined by a user.

5. The sensor system of claim 1, wherein the tilt sensor is configured to determine whether:
the angle of tilt exceeds a tilt threshold; or
the change in angle of tilt exceeds a tilt change threshold.

6. The sensor system of claim 5, wherein the communication interface is configured to remain inactive while the angle of tilt does not exceed the tilt threshold, and the tilt sensor is configured to activate the communication interface based on determining that the angle of tilt exceeds a tilt threshold.

7. The sensor system of claim 6, wherein the communication interface is configured to transmit the sensor signal upon activation.

8. The sensor system of claim 1, wherein the tilt sensor further comprises a thermometer configured to measure air temperature, and wherein the sensor signal further includes the air temperature.

9. The sensor system of claim 1, further comprising a controller configured to receive the sensor signal.

10. The sensor system of claim 9, further comprising a server, wherein the server is configured to:
receive, from the controller, the angle of tilt;
determine that the angle of tilt exceeds a predefined tilt threshold; and
based on determining that the angle of tilt exceeds the predefined tilt threshold, provide a tilt alert to a user device.

11. The sensor system of claim 10, wherein the server is further configured to:
receive, from the controller, the wind speed;
determine that the wind speed exceeds a predefined wind speed threshold; and
based on determining that the wind speed exceeds the predefined wind speed threshold, provide a wind speed alert to a user device.

12. The sensor system of claim 11, wherein the server is further configured to provide the wind speed alert based on the wind speed and the wind direction.

13. A method of monitoring tilt of a vertical structure, comprising:
detecting at least one of an angle of tilt or a change in angle of tilt of the vertical structure;
detecting at least one of a wind speed or a wind direction at the vertical structure; and
transmitting a sensor signal that includes at least one of the angle of tilt or the change in angle of tilt, and at least one of the wind speed or wind direction.

14. The method of claim 13, wherein detecting the angle of tilt or the change in angle of tilt is performed periodically at an interval of time.

15. The method of claim 14, wherein the interval of time is determined by a user.

16. The method of claim 13, further comprising determining whether:
the angle of tilt exceeds a tilt threshold; or
the change in angle of tilt exceeds a tilt change threshold.

17. The method of claim 16, wherein transmitting the sensor signal is performed based on the determination that the angle of tilt exceeds the tilt threshold.

18. A method of monitoring tilt of a vertical structure, comprising:
receiving a sensor signal from a tilt sensor, the sensor signal including an angle of tilt of the vertical structure;
determining that the angle of tilt exceeds a predefined tilt threshold; and
providing a tilt alert to a user device based on the determination that the angle of tilt exceeds the predefined tilt threshold.

19. The method of claim 18, wherein the sensor signal further includes a wind speed as measured by the tilt sensor, the method further comprising:
determining that the wind speed exceeds a predefined wind speed threshold; and
providing a wind speed alert to the user device based on the determination that the wind speed exceeds the predefined wind speed threshold.

20. The method of claim 19, wherein the sensor signal further includes a wind direction as measured by the tilt sensor, the method further comprising:
providing the wind speed alert based on the wind speed and the wind direction.
